(19) United States
(12) Patent Application Publication
(10) Pub. No.: US 2005/0084732 A1
(43) Pub. Date: Apr. 21, 2005

(54) Fuel cell stack having an improved current collector and insulator

(76) Inventors: Richard D. Breault, North Kingstown, RI (US); Ryan J. Balliet, West Hartford, CT (US); Robert R. Fredley, Tolland, CT (US); Patrick L. Hagans, Columbia, CT (US)

Correspondence Address: Malcolm J. Chisholm, Jr., 220 Main Street, P.O. Box 278, Lee, MA, 01238, US

(21) Appl. No.: 10/687,242

(22) Filed: Oct. 16, 2003

(51) Int. Cl. H01M 8/24; H01M 8/04

(52) U.S. Cl. 429/34; 429/37; 429/26; 429/13

(57) ABSTRACT

A fuel cell stack (10) includes a reaction portion (20) having an end cell (12) secured adjacent to a current collector (30). The collector (30) has a sensible heat no greater than a sensible heat of the end cell (12) and an electrical resistivity no greater than 100 micro-ohms centimeters. An insulator (40) is secured adjacent the collector (30) and has a thermal conductivity that is no greater than 0.500 Watts per meter per degree Kelvin. Because of the low sensible heat of the current collector (30) and low rate of heat transfer of the insulator (40), heat does not readily leave the end cell (12) resulting in a rapid heating of the end cell (12), thereby avoiding freezing and accumulation of product water in the end cell (12) during start up in subfreezing conditions.

### TECHNICAL FIELD

The present invention relates to fuel cells that are arranged in fuel cell stacks that are suited for usage in transportation vehicles, portable power plants, or as stationary power plants, and the invention especially relates to a fuel cell stack having a current collector that has a low sensible heat compared to an end cell of the stack and an insulator wherein a rate of heat transfer across the insulator is no greater than a rate of heat production by the end cell during start up from subfreezing conditions.

### BACKGROUND ART

Fuel cells are well-known and are commonly used to produce electrical energy from reducing and oxidizing reactant fluids to power electrical apparatus, such as apparatus on-board space vehicles, transportation vehicles, or as on-site generators for buildings. A plurality of planar fuel cells are typically arranged into a cell stack surrounded by an electrically insulating frame structure that defines manifolds for directing flow of reducing, oxidant, coolant and product fluids as part of a fuel cell power plant. Each individual fuel cell generally includes an anode electrode and a cathode electrode separated by an electrolyte. A fuel cell may also include a water transport plate, or a separator plate, as is well known.

The fuel cell stack produces electricity from reducing fluid and process oxidant streams. A reaction portion of the fuel cell stack is formed from a plurality of fuel cells stacked adjacent each other. The plurality of fuel cells includes an end cell at an end of the stack of fuel cells. A pressure plate overlies the current collector and is secured to an opposed pressure plate at an opposed end of the cell stack to apply a compressive load to the stack. Most known pressure plates are made of large, conductive metal materials.

During operation of the fuel cell stack, current flows through and out of the reaction portion of the stack and into a current collector adjacent the end cell. A power take-off secured to the current collector or pressure plate directs the current out of the cell stack to a load, such as a motor.

During a “bootstrap” start up from subfreezing conditions, preferably no auxiliary heated fluids are applied to the fuel cell stack, while a reducing fluid, such as hydrogen, is supplied to the anode electrode, and an oxidant, such as oxygen or air, is supplied to the cathode electrode. In a cell utilizing a proton exchange membrane (“PEM”) as the electrolyte, the hydrogen electrochemically reacts at a catalyst surface of the anode electrode to produce hydrogen ions and electrons. The electrons are conducted to an external load circuit and then returned to the cathode electrode, while the hydrogen ions transfer through the electrolyte to the cathode electrode, where they react with the oxidant and electrons to produce water and release thermal energy. Electricity produced by the fuel cell flows into and through the current collector and a conductive pressure plate.

During such a “bootstrap” start up, the fuel cells that are in a central region of the stack quickly rise in temperature compared to the end cells that are adjacent opposed ends of the stack. The end cells heat up more slowly because heat generated by the end cells is rapidly conducted into and through the current collector and into the large, conductive metallic pressure plate. If a temperature of the end cells is not quickly raised to greater than 0 degrees Celsius (“° C.”), water in the water transport plates will remain frozen thereby preventing removal of product water, which results in the end cells being flooded with fuel cell product water. The flooding of the end cells retards reactant fluids from reaching the catalysts and may result in a negative voltage in the end cells. The negative voltage in the end cells may result in hydrogen gas evolution at the cathode electrode and/or corrosion of carbon support layers of electrodes of the cell. Such occurrences would degrade the performance and long-term stability of the fuel cell stack.

Accordingly, there is a need for a fuel cell stack having an end cell wherein the temperature can be raised to greater than 0° C. as quickly as possible during start up from subfreezing conditions.

### DISCLOSURE OF INVENTION

The invention is a fuel cell stack having an improved current collector and insulator. The fuel cell stack can be used in a fuel cell power plant (not shown), such as a plant that includes the stack and such other components as for example, a reactant management system, a thermal management system, and a controller, to produce a power plant that can interface with and supply electrical energy to an external load. Such plants and their various components are well known to one skilled in the art. The external load that receives power from the fuel cell may be a transportation or a stationery device, such as a vehicle or a building for example. The fuel cell stack produces electricity from reducing fluid and process oxidant streams, and comprises a plurality of fuel cells stacked adjacent each other to form a reaction portion of the fuel cell stack. The plurality of fuel cells includes an end cell at an end of the stack.

A current collector is secured in electrical communication with the end cell, wherein the current collector has a sensible heat no greater than a sensible heat of the end cell and an electrical resistivity no greater than 100 micro-ohm centimeters. The fuel cell stack also includes an insulator secured adjacent the current collector, wherein a thermal conductivity of the insulator is no greater than 0.500 Watts per meter per degree Kelvin. The stack also includes a pressure plate secured adjacent and overlying the insulator and overlying the end cell. Because of the low sensible heat of the current collector and because of the low thermal conductivity of the insulator, heat does not readily leave the end cell, resulting in a rapid warm up of the end cell during start up in subfreezing conditions.

In one embodiment, the current collector is made from a metal foil. In an alternative embodiment, the current collector may consist of a metal coating. A preferred current collector may be a gold plated layer of tin with a thickness of 0.25-0.50 millimeter (“mm”) and with a sensible heat of approximately 0.13-0.26 times the sensible heat of an end cell.

Preferred insulators may include a closed cell plastic with a thermal conductivity of no greater than 0.010 Watts per meter per degree Kelvin, a silica aerogel with a thermal conductivity of no greater than 0.010 Watts per meter per degree Kelvin, or a silica aerogel within a vacuum insulation panel with a thermal conductivity of no greater than 0.005 Watts per meter per degree Kelvin. Preferred insulators may also have a compressive strength in excess of 350 kilo Pascals.

The invention may utilize a pressure plate made of a metallic, conductive material or made of a non-metallic, non-conductive, reinforced plastic composite.

Accordingly, it is a general purpose of the present invention to provide a fuel cell stack having an improved current collector and insulator that overcomes deficiencies of the prior art.

It is a more specific purpose to provide a fuel cell stack having an improved current collector and insulator that provides a current collector having a low sensible heat and an insulator having a low thermal conductivity so that an end cell of the fuel cell stack heats up rapidly during start up in subfreezing conditions.

These and other purposes and advantages of the present fuel cell stack having an improved current collector and insulator will become more readily apparent when the following description is read in conjunction with the accompanying drawings.

### BRIEF DESCRIPTION OF THE DRAWING

FIG. 1 is a simplified schematic representation of a preferred embodiment of a fuel cell stack having an improved current collector and insulator constructed in accordance with the present invention.

FIG. 2 is a fragmentary perspective view of the FIG. 1 fuel cell stack showing bus bars secured to long-sides of the fuel cell stack.

FIG. 3 is a simplified schematic representation of an alternative embodiment of a fuel cell stack having an improved current collector and insulator.

FIG. 4 is a graph of current collector thicknesses as a function of various materials.

FIG. 5 is a graph of sensible heat of current collectors as a percentage of sensible heat of one fuel cell as a function of various materials.

FIG. 6 is a graph of an end cell temperature measured in degrees Celsius (“° C.”) as a function of time measured in seconds during a bootstrap start up.

### DESCRIPTION OF THE PREFERRED EMBODIMENTS

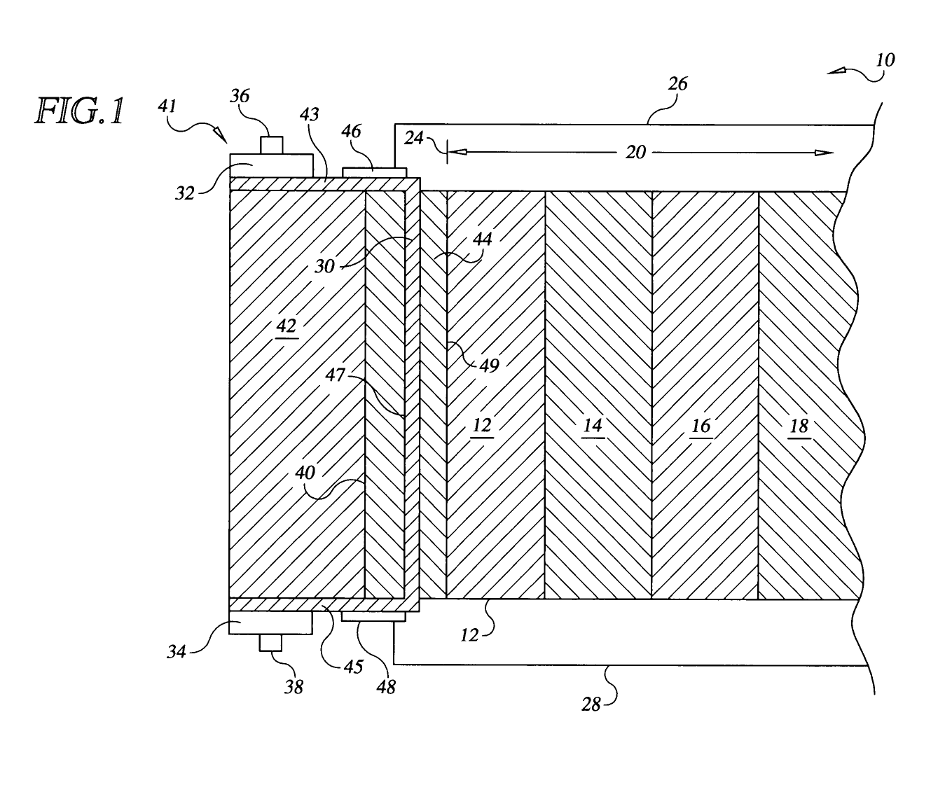

Referring to the drawings in detail, a fuel cell stack having an improved current collector and insulator is shown in FIG. 1, and is generally designated by the reference numeral 10. The stack 10 includes a plurality of fuel cells 14, 16, 18 secured adjacent each other that form a reaction portion 20 of the stack 10. As is well known in the art, the fuel cells 14, 16, 18 of the stack 10 include anode and cathode electrodes (not shown) on opposed sides of electrolytes (not shown), such as PEM electrolytes. Such fuel cells 14, 16, 18 may also include water transport plates and/or separator plates (not shown) as is well known. The stack 10 also includes an end cell 12 secured adjacent a first end 24 of the reaction portion 20 of the stack 10. The stack 10 may also include a first reactant manifold 26 and a second reactant manifold 28 secured to the reaction portion 20 of the stack 10 for directing reactant streams, such as reducing fluid and process oxidant streams into the reaction portion 20 of the stack 10, and for directing product streams out of the stack 10, as is well known in the art.

A current collector 30 is secured in electrical communication with the end cell 12. The current collector 30 is dimensioned so that a planar area of the current collector 30 is at least as large as a planar area of the end cell 12 in order to enhance the conduction of electricity between the end cell 12 and the current collector 30. The current collector 30 is secured in electrical communication with a first bus bar 32 and a second bus bar 34. The bus bars 32, 34 may be formed from a conductive material, such as copper, so that a current flowing from the current collector 30 can be directed to the bus bars 32, 34. Additionally, a first power take-off 36 is secured to the first bus bar 32 and a second power take-off 38 is secured to the second bus bar 34. The first and second power take-offs 36, 38 may be formed from conductive material for conducting electricity from the stack 10 to a load (not shown) for performing work. The current collector 30 has a sensible heat that is less than a sensible heat of the end cell 12, and the current collector has an electrical resistivity no greater than 100 micro-ohm centimeters. In other words, the end cell 12 has first sensible heat, and the current collector 30 has a second sensible heat that is less than the first sensible heat.

The stack 10 also includes an insulator 40 secured adjacent the current collector 30 or adjacent at least a portion of the current collector 30. A pressure plate 42, such as a layer of an electrically non-conductive, non-metallic, fiber reinforced composite material is secured to an outer end 41 of the stack 10 adjacent and overlying the insulator 40 and overlying the end cell 12. For purposes herein, the phrase “the pressure plate 42 overlying the end cell 12”, will mean that the pressure plate 42 is dimensioned to have a planar area at least as large as a planar area of the end cell 12. A second current collector, insulator and pressure plate (not shown) would be secured to an opposed second end cell (not shown) of the stack 10. As is known, the pressure plates are secured to each other, such as by tie rods (not shown), to apply a compressive load to the stack 10.

The stack 10 may also include a carbon paper cushion 44 secured adjacent the current collector 30. As is known in the art, the carbon paper cushion 44 is compressible for enhanced conductivity between adjacent surfaces of the stack 10. Furthermore, the stack 10 may include a first gasket 46 secured between the current collector 30 and first reactant manifold 26 and a second gasket 48 secured between the current collector 30 and second reactant manifold 28. The first and second gaskets 46, 48 prohibit movement of fluids out of the manifolds 26, 28.

If the pressure plate 42 is an electrically non-conductive, non-metallic, fiber reinforced composite pressure plate 42, then the current collector 30 may include a first long-side extension 43 and an opposed second long-side extension 45 that extend from a planar surface 47 of the current collector 30 that is co-planar with a contact surface 49 of the end cell 12. The first and second long-side extensions 43, 45 contact the first and second bus bars 32, 34.

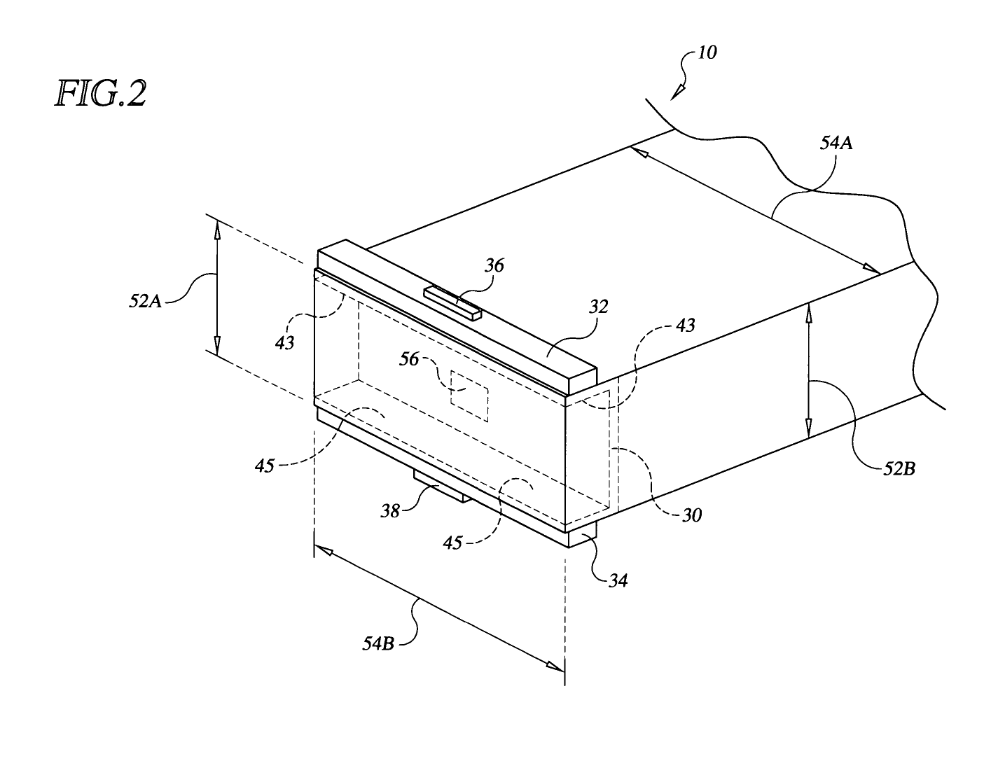

FIG. 2 is a fragmentary perspective of the FIG. 1 fuel cell stack 10 and would be as described above for the first embodiment shown in FIG. 1. FIG. 2 (not drawn to scale) shows the positioning of the first and second long-side extensions 43, 45 of the current collector 30 in relation to the cell stack 10. The stack 10 is rectangular and includes first and second short-sides 52A, 52B and first and second long-sides 54A, 54B. The first long-side extension 43 is positioned to extend along the first-long side 54A of the stack 10 and the second long-side extension 45 is positioned to extend along the second-long side 54B of the stack 10 as shown in FIG. 2. By this arrangement, electrical current flowing from a central area 56 of the current collector 30 into the bus bars 32, 34 can travel a shorter distance to the first or second long-side extensions 43, 45, instead of a longer distance to the short-sides 52A, 52B of the stack 10. Therefore, current flowing the shorter distance to the long-sides 54A, 54B allows the current collector 30 to be thinner than if the current had to flow further to the short-sides 52A, 52B. A thinner current collector 30 has a lower sensible heat compared to a thicker current collector 30.

As is known, sensible heat of an item is the product of its mass multiplied by its specific heat multiplied by a temperature differential over which it is being heated. Therefore, for example, the sensible heat of one gram of water raised from 0 degrees Celsius (“° C.”) to 20° C. is different than the sensible heat of one gram of concrete raised from 0° C. to 20° C. Thus the lower the sensible heat of the current collector 30, the lower an amount of heat transferred from the end cell 12 to the current collector 30 to raise its temperature. Reducing an amount of heat transferred from the end cell 12 to the current collector 30 leaves more heat in the end cell 12, thereby facilitating a rapid warm up of the end cell 12 during start up in subfreezing conditions.

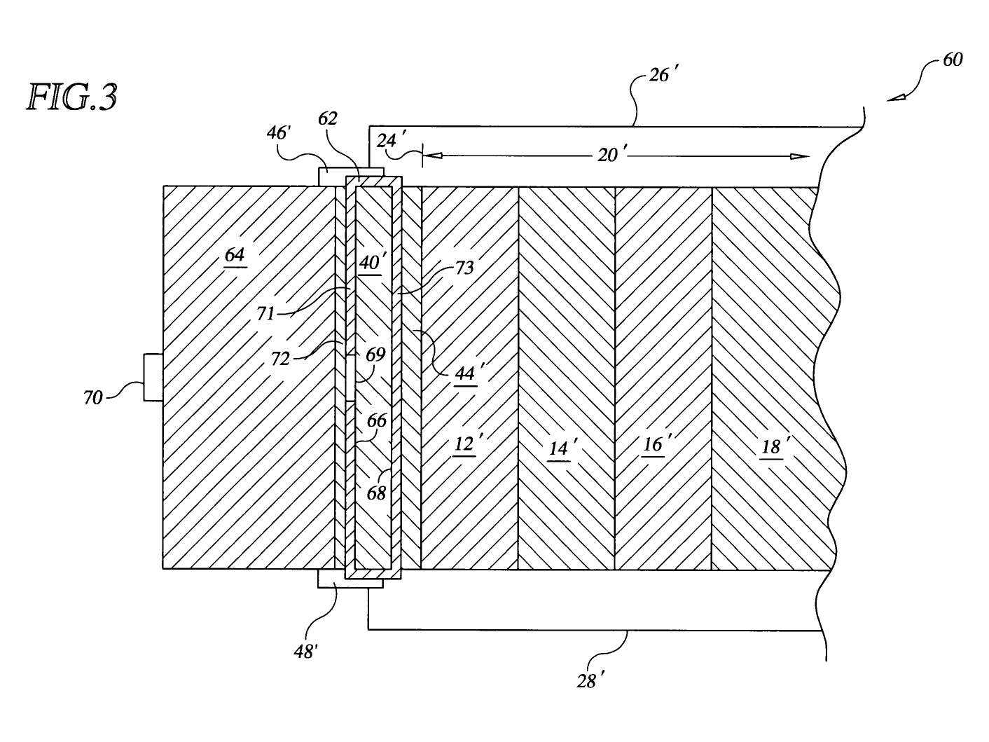

In FIG. 3, an alternative embodiment of the fuel cell stack 60 having an improved current collector and insulator is shown. For purposes of efficiency, those components of the alternative embodiment that are virtually the same as comparable elements in the embodiment described above and shown in FIG. 1 are shown in FIG. 3 having a prime of the same reference numeral shown in FIG. 1. For example, the end cell 12 shown in FIG. 1 is designated by the reference numeral 12′ in FIG. 3.

The alternative embodiment of the stack 60 includes a plurality of fuel cells 14′, 16′, 18′ that form a reaction portion 20′ of the stack 60. Also, the stack 60 includes an end cell 12′ secured adjacent a first end 24′ of the reaction portion 20′ of the stack 60.

A current collector 62 is secured in electrical communication with an insulator 40′ and a pressure plate 64. The current collector 62 may wrap around the insulator 40′. In such an embodiment, the current collector 62 would be a uniform piece folded so that a first folded layer 71 of the current collector 62 is secured adjacent a first contact surface 66 of the insulator 40′ and a second folded layer 73 of the current collector 62 is secured adjacent a second contact surface 68 of the insulator 40′.

A preferred total thickness across the current collector 30 of FIGS. 1 and 2, or across either the first folded layer 71 or the second folded layer 73 of the FIG. 3 current collector 62, is no greater than 1.00 mm thick. For purposes herein, “thick” means a shortest distance through the current collector 30 or 62 parallel to a longitudinal axis extending between the end cell 12 and the pressure plate 42 in FIG. 1, or between the end cell 12′ and pressure plate 64 of FIG. 3. Electrical power transfer between the FIG. 3 current collector 62 and the conductive pressure plate 64 is simplified by wrapping the insulator 40′ with the current collector 62. The bus bars 32, 34 shown in FIG. 1 are not required with the configuration shown in FIG. 3. The FIG. 3 current collector 62 may have a gap 69 for accommodating manufacturing tolerances.

In the FIG. 3 fuel cell stack 60, the pressure plate 64 is made from an electrically conductive, metallic material, such as stainless steel, and is secured adjacent and overlying the current collector 62 and overlying the end cell 12′. Furthermore, a power take-off 70 is secured to the pressure plate 64 for conducting electrical current out of the stack 60.

The stack 60 may also include a first carbon paper cushion 44′ secured between the current collector 62 and end cell 12′ and a second carbon paper cushion 72 secured between the current collector 62 and pressure plate 64. Because the pressure plate 64 is electrically conductive, no long-side extensions of the current collector 62 are necessary.

In the embodiments shown in FIGS. 1-3, the current collector 30, 62 may be made from a clad metal such as a stainless steel clad to nickel or copper. Alternatively, the current collector may be made of materials selected from the group consisting of tin, copper, zinc, nickel, aluminum, gold, silver, alloys thereof, mixtures thereof, and these materials with gold plating. Both surfaces of such a clad metal current collector, 30, 62 are preferably gold plated to minimize corrosion and contact resistance. Such clad metals are available from the Engineered Materials Solution company of Attleboro, Mass., U.S.A. The clad metal has and advantage combining a corrosion resistant stainless steel with a high electrical conductivity, less corrosion resistant material. Such a clad metal is preferably oriented so that the more corrosion resistant material is adjacent to the end cell 12. The current collectors 30, 62 may also be made from a metal foil, metal coating, or metal plating such as tin. The current collector 30, 62 applied as a coating may be applied to the insulator 40, 40′. A 0.25 mm thick tin current collector with a sensible heat of about 0.13-0.26 times the sensible heat of an end cell 12 and a resistivity no greater than 100 micro-ohm centimeters is preferred.

Also, the insulator 40, 40′ has a thermal conductivity that is no greater than 0.500 Watts per meter per degree Kelvin, and is secured to the current collector 30, 62 so that a total rate of heat transfer across the insulator from the end cell 12 is no greater than heat generated by the end cell 12. The insulator 40, 40′ may consist of: a) a closed or open cell plastic with a thermal conductivity of no greater than 0.010 Watts per meter per degree Kelvin; b) a silica aerogel with a thermal conductivity of no greater than 0.010 Watts per meter per degree Kelvin; or c) a silica aerogel within a vacuum insulation panel with a thermal conductivity of no greater than 0.005 Watts per meter per degree Kelvin. A preferred thickness of the insulator 40, 40′ is less that 20 mm, and most preferably less than 10 mm.

During operation of the stack 10, a rate of heat transfer into or across the insulator 40, 40′ is less than one-hundred percent (“%”) of the rate of heat generated by the end cell 12 during the first minute of a “bootstrap” start; a preferred rate of heat transfer into the insulator 40, 40′ is less than 50% of the rate of heat generated by the end cell 12; and, a most preferred rate of heat transfer into the insulator 40, 40′ is less than 25% of the rate of heat generated by the end cell 12 during the first minute of such a start up. The rate of heat generated by a single cell during such a start up is about 0.2 watts per square centimeter. The insulator 40, 40′ also preferably has a compressive strength in excess of 350 kilo Pascals.

An exemplary open cell plastic insulation is a product marketed under the trade name “Pyropel MD-50”, made from rigid, lightweight polyimide fiberboards, available from Albany International company of Mansfield, Mass., U.S.A. An exemplary silica aerogel insulator is a product marketed under the trade name of “Aspen Aerogel”, available from Aspen Aerogels, Inc. of Marlborough, Mass., U.S.A. An exemplary silica aerogel within vacuum panels is a product marketed under the trade name of “Barrier Ultra-R”, available from Glacier Bay company of Oakland, Calif., U.S.A.

Exemplary materials for making the non-conductive pressure plate 42 include a glass or fiber reinforced polymer or resin that is compatible with the operating conditions of the fuel cell stack 10. Exemplary fiber reinforced composite materials include products available from the Quantum Composites, Company, of Bay City Mich., U.S.A., distributed under the following trade designations: a) “LYTEX 9063”, 63% glass fiber epoxy SMC; b) “LYTEX 4149”, 55% carbon fiber epoxy SMC; c) “QC8560” glass fiber reinforced vinyl ester resin SMC; and, d) “QC8880” glass fiber reinforced vinyl ester resin SMC.

It is known that during a “bootstrap” start up, the fuel cells 14, 16, 18 that are not in contact with the current collector 30 quickly rise in temperature compared to the end cell 12 of the stack 10. The end cell 12 heats up more slowly because heat generated by the end cell 12 would move rapidly into a prior art current collector and pressure plate (not shown). For example, a common prior art pressure plate is a stainless steel pressure plate with a sensible heat approximately 41 times the sensible heat of a fuel cell. Because of the high sensible heat of the pressure plate and the end cell not heating up rapidly as possible, the end cell may be flooded with product water and frozen product water in sub-freezing ambient conditions. The flooding of the end cell may result in a negative voltage in the end cells and may degrade the performance and long-term stability of the fuel cell stack.

In solving the problem of heat loss by the end cells 12, 12′ the inventors contrasted various materials for minimal thickness of the current collectors 30, 62 for an exemplary fuel cell (not shown) at specific operating conditions. Although various materials can be used as current collectors, a tin current collector coated with gold is the preferred material because gold maintains a low electrical resistivity between the current collector 30 and carbon paper cushion 44 and because tin forms a virtually insoluble tin oxide in a PEM cell and is easily fabricated.

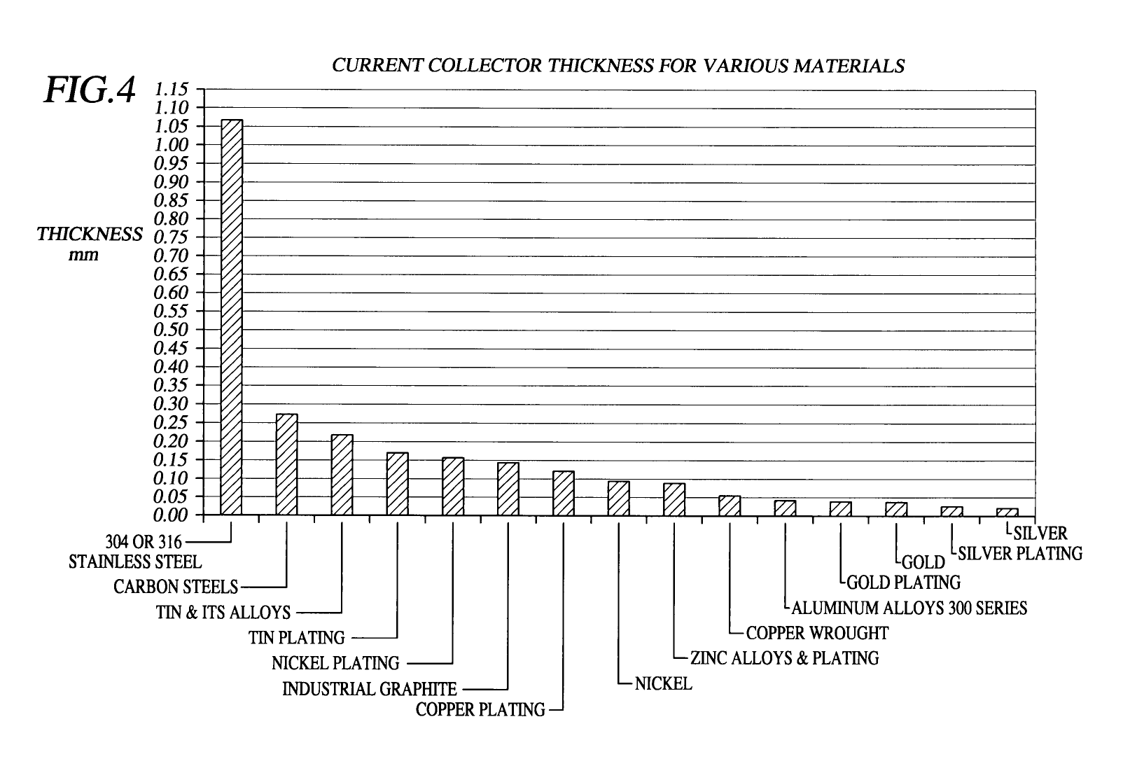

FIG. 4 shows a graph of current collector thicknesses measured in millimeters (“mm”) as a function of various materials wherein the measured thicknesses sustain operation of the exemplary fuel cell at the specific conditions. The following are the specific conditions of the exemplary fuel cell: a) a cell size of 15.24×30.48 centimeters (“cm”); b) a current density of 1.0 amperes per centimeter squared (“amp/cm²’); and c) an allowable voltage drop of 0.020 volts (“v”) from a center line of the cell to an edge of the cell (not shown). The chart shows materials, including 304 or 316 stainless steel, carbon steels, and tin and its alloys.

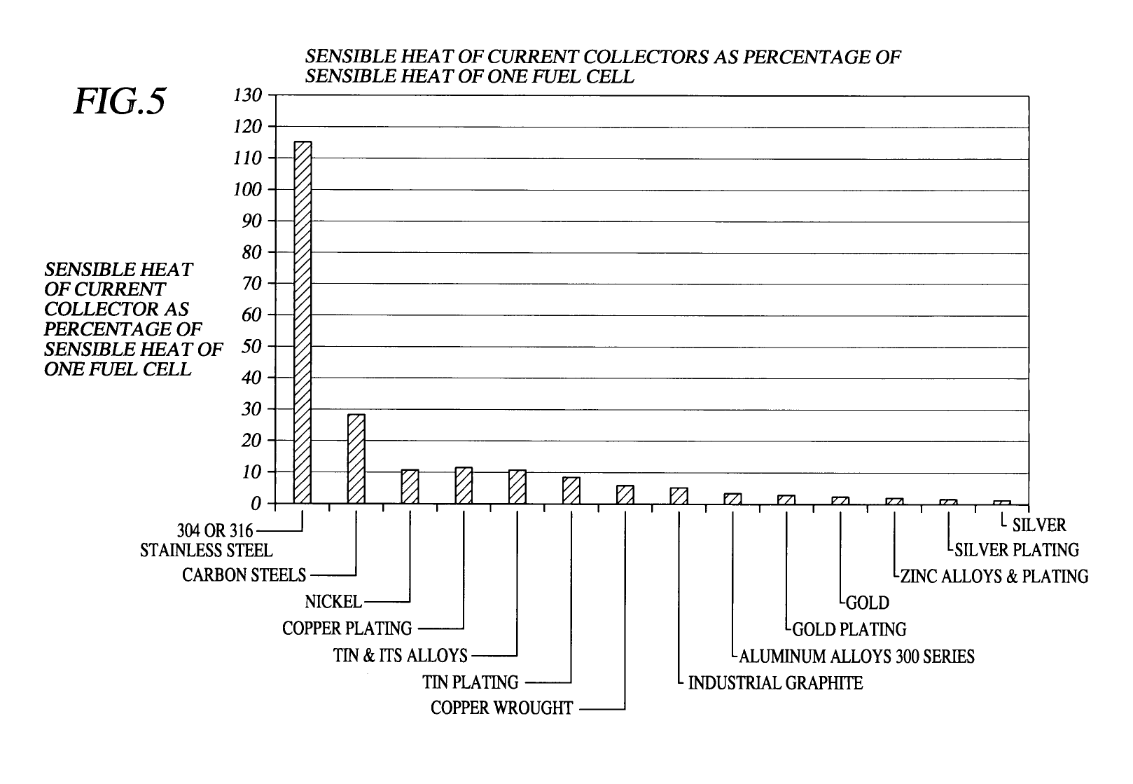

FIG. 5 shows a graph of sensible heat of current collectors of various materials as a percentage of sensible heat of one fuel cell for the current collector thicknesses shown in FIG. 4. Thus, FIG. 5 demonstrates the sensible heat of the FIG. 4 current collectors. For example, the sensible heat of a 1.05 mm thick stainless steel current collector is approximately 1.15 times the sensible heat of an adjacent end cell in the exemplary fuel cell. The sensible heat of a 0.25 mm thick tin current collector 30 is about 0.13 times the sensible heat of an exemplary end cell. This means that most of the waste heat produced in the end cell can be utilized to raise the temperature of the end cell instead of being conducted into the current collector. Therefore, the exemplary end cell, such as the end cell 12, would rapidly warm up during start up in subfreezing conditions.

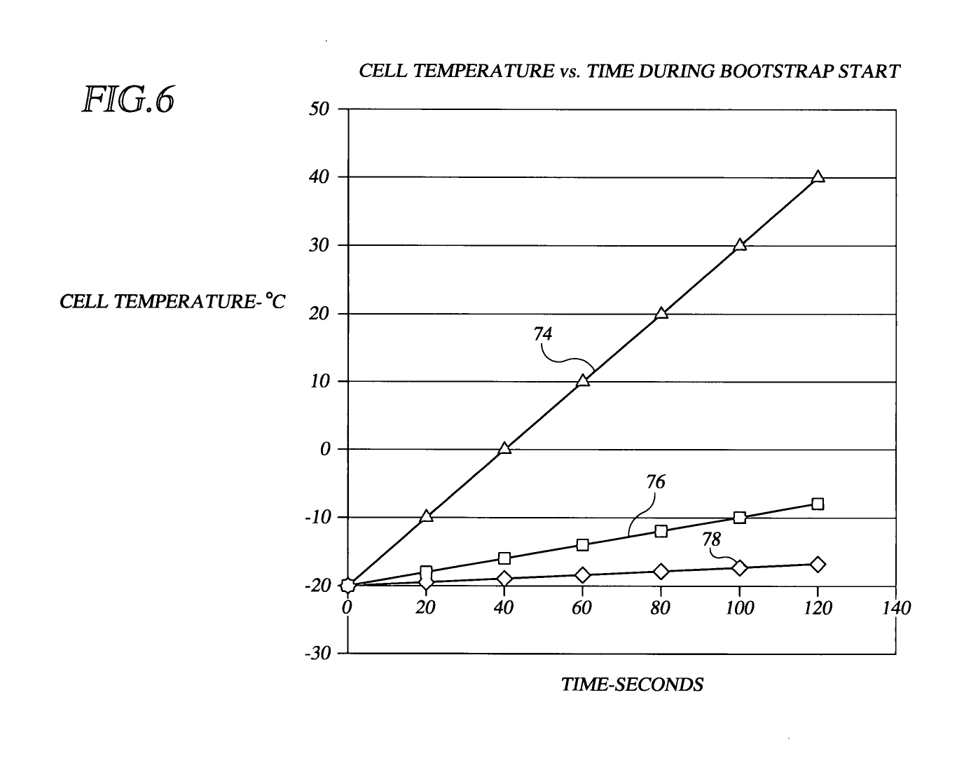

FIG. 6 shows a graph of an exemplary end cell temperature change in degrees Celsius (“° C.”) as a function of time measured in seconds during a bootstrap start up with current collectors made of three different materials. The resulting proof-of-concept shown in FIG. 6 contrasts: a) a tin current collector with a stainless steel pressure plate and a “Pyropel” brand open cell plastic insulation represented by the line in FIG. 6 designated by reference numeral 74; b) a stainless steel current collector with a composite pressure plate represented by the line in FIG. 6 designated by reference numeral 76; and c) a stainless steel current collector with a stainless steel pressure plate represented by the line in FIG. 6 designated by reference numeral 78. Line 74 represents a 0.50 mm tin current collector with a 8.0 mm “Pyropel” brand insulation with a conductivity of 0.07 Watts per meter per degree Kelvin (“w/m°K”) and with a 30.0 mm stainless steel pressure plate. Line 76 represents a 2.0 mm stainless steel current collector and composite pressure plate with no insulation. Line 78 represents a 38.0 mm stainless steel current collector and stainless steel pressure plate with no insulation.

To raise the temperature of the end cell to 0° C. as quickly as possible and in less than 60 seconds, it is apparent that the 0.50 mm tin current collector with the 8.0 mm insulator and the 30.0 mm stainless steel pressure plate of line 74 achieve a remarkably rapid warming from −20° C. to 0° C. in less than or equal to 40 seconds. In contrast, the 2.0 mm stainless steel current collector and composite pressure plate of line 76 and the 38.0 mm stainless steel current collector and stainless steel pressure plate of line 78 do not warm up from −20° C. to 0° C. in less than 2 minutes. Thus, it is apparent that a thin current collector 40, 62 having a sensible heat less than the sensible heat of the end plate 12, 12′, with an insulator secured between the current collector and the pressure plate 42, 64 is a preferred configuration that results in a rapid heating of the end cell 12, 12′ during a bootstrap start.

While the present invention has been described and illustrated with respect to a particular construction of a fuel cell stack 10 having an improved current collector and insulator it is to be understood that the invention is not to be limited to the described and illustrated embodiments. For example, while the fuel cells 14, 16, 18 including individual fuel cells are described as having anode and cathode electrodes on opposed sides of PEM electrolytes, the invention may be applied to fuel cells utilizing other known electrolytes. Additionally, the current collector 30, insulator 40 and pressure plate 42 of the described and illustrated embodiments are shown being secured adjacent only the illustrated end cell 12. However, it is to be understood that the fuel cell stack 10 in most circumstances would include a second current collector, insulator and pressure plate (not shown) like the described components adjacent a second end cell (not shown). Accordingly, reference should be made primarily to the following claims rather than the foregoing description to determine the scope of the invention.

1. A fuel cell stack (10) for producing electricity from reducing fluid and process oxidant reactant streams, the stack comprising:
a. a plurality of fuel cells (14), (16), (18) secured adjacent each other to form a reaction portion (20) of the fuel cell stack (10), the plurality of fuel cells (14), (16), (18) including an end cell (12) secured adjacent a first end (24) of the reaction portion (20) of the stack (10);
b. a current collector (30) secured adjacent the first end (24) and secured in electrical communication with the end cell (12), wherein the current collector (30) has a sensible heat less than a sensible heat of the end cell (12) and an electrical resistivity no greater than 100 micro-ohm centimeters;
c. an insulator (40) secured adjacent the current collector (30), wherein a thermal conductivity across the insulator (40) is no greater than 0.500 Watts per meter per degree Kelvin, the insulator (40) being secured to the current collector (30) so that a total rate of heat transfer across the insulator (40) from the end cell (12) is no greater than heat generated by the end cell (12); and,
d. a pressure plate (42) secured adjacent and overlying the insulator (40) and overlying the end cell (12).

2. The fuel cell stack (10) of claim 1, wherein the sensible heat of the current collector (30) is no greater than fifty percent of the sensible heat of the end cell (12).

3. The fuel cell stack (10) of claim 1, wherein the sensible heat of the current collector (30) is no greater than twenty-five percent of the sensible heat of the end cell (12).

4. The fuel cell stack of claim 1, wherein the insulator (40) has a thermal conductivity of no greater than 0.005 Watts per meter per degree Kelvin.

5. The fuel cell stack (10) of claim 1, wherein the insulator (40) has a thermal conductivity of no greater than 0.010 Watts per meter per degree Kelvin and the insulator has a compressive strength in excess of 350 kilo Pascals.

6. The fuel cell stack (10) of claim 1, wherein the insulator (40) is a vacuum insulation panel with a thermal conductivity of no greater than 0.005 Watts per meter per degree Kelvin and the insulator has a compressive strength in excess of 350 kilo Pascals.

7. The fuel cell stack (10) of claim 1, wherein the insulator (40) has a thickness of less than 20 millimeters.

8. The fuel cell stack (10) of claim 1, wherein the insulator (40) has a thickness of less than 10 millimeters.

9. The fuel cell stack (10) of claim 1, wherein the insulator (40) has a total rate of heat transfer across the insulator (40) from the end cell (12) that is less than fifty percent of heat generated by the end cell (12).

10. The fuel cell stack (10) of claim 1, wherein the insulator (40) has a total rate of heat transfer across the insulator (40) from the end cell (12) that is less than twenty-five percent of heat generated by the end cell (12).

11. The fuel cell stack (10) of claim 1, wherein the pressure plate (42) is an electrically conductive metal.

12. The fuel cell stack (10) of claim 1, wherein the pressure plate (42) is made of an electrically non-conductive, non-metallic, fiber reinforced composite material.

13. The fuel cell stack (10) of claim 12, wherein the current collector (30) includes a first long-side extension (43) positioned to extend along a first long-side (54A) of the stack (10) and adjacent the electrically non-conductive pressure plate (42), and a second long-side extension (45) positioned to extend along a second long-side (54B) of the stack (10) and adjacent the electrically non-conductive pressure plate (42), a first power take-off (36) secured in electrical communication with the first long-side extension (43), and a second power take-off (38) secured in electrical communication with the second long-side extension (45) to effect electrical flow through the current collector (30) and to the first and second power take-offs (36), (38).

14. The fuel cell stack (10) of claim 1, wherein the current collector (30) is a metal foil.

15. The fuel cell stack (10) of claim 1, wherein the current collector (30) is a metal coating on the insulator (40).

16. The fuel cell stack (10) of claim 1, wherein the current collector (30) is no greater than 1.00 millimeter thick.

17. The fuel cell stack (10) of claim 1, wherein the current collector (30) is no greater than 0.50 millimeter thick.

18. The fuel cell stack (10) of claim 1, wherein the current collector (30) is no greater than 0.25 millimeter thick.

19. The fuel cell stack (10) of claim 1, wherein the current collector (30) has an electrical resistivity no greater than 50 micro-ohm centimeters.

20. The fuel cell stack (10) of claim 1, wherein the current collector (30) has an electrical resistivity no greater than 25 micro-ohm centimeters.

21. The fuel cell stack (10) of claim 1, wherein the current collector (30) is made of a material selected from the group consisting of tin, copper, zinc, nickel, aluminum, gold, silver, alloys thereof, mixtures thereof, and these materials with gold plating.

22. A fuel cell power plant for supplying electricity to and external load, comprising:
a. a fuel cell stack (10) with a reaction portion (20), the reaction portion having and end cell (12) with a first sensible heat;
b. a current collector (30) secured in electrical communication with the end cell (12), having a second sensible heat that is less than the first sensible heat, and having an electrical resistivity no greater than 100 micro-ohm centimeters;
c. a pressure plate (42) secured to an outer end (41) of the fuel cell stack (10); and,
d. an insulator (40) disposed between the pressure plate (42) and at least a portion of the current collector (30), the insulator having a thermal conductivity no greater than 0.500 Watts per meter degree Kelvin.

23. The fuel cell power plant of claim 22, wherein the external load is an electric drive component of a transportation device.

24. The fuel cell power plant of claim 22, wherein the external load is a stationary device.

25. A method of rapidly warming up an end cell (12) of a fuel cell stack (10) during a start up of the fuel cell stack (10), the fuel cell stack (10) including a plurality of fuel cells (14), (16), (18) secured adjacent to each other to form a reaction portion (20) of the stack (10), including the end cell (12) secured adjacent a first end (24) of the stack (10), the method comprising the steps of:
a. securing a current collector (30) adjacent to the first end (24) and in electrical communication with the end cell (12), the current collector (30) having a sensible heat less than a sensible heat of the end cell (12) and an electrical resistivity no greater than 100 micro-ohm centimeters;
b. securing an insulator (40) adjacent the current collector (30), the insulator (40) having a thermal conductivity that is no greater than 0.500 Watts per meter per degree Kelvin, the insulator being (40) secured to the current collector (30) so that a total rate of heat transfer across the insulator (40) from the end cell (12) is no greater than heat generated by the end cell (12);
c. securing a pressure plate (42) adjacent and overlying the insulator (40) and overlying the end cell (12); and,
d. then, directing reactant fluids to flow through the fuel cells (12), (14), (16), (18).
